(19) United States
(12) Patent Application Publication
(10) Pub. No.: US 2008/0093842 A1
(43) Pub. Date: Apr. 24, 2008

(54) Rotary leadthrough, especially for the drive train of a motor vehicle

(75) Inventors: Michael Kuhner, Schwanfeld (DE); Cora Carlson, Hambach (DE); Andreas Orlamunder, Schonungen (DE); Roman Esterl, Frankfurt (DE); Thomas Dogel, Bad Kissingen (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/974,868

(22) Filed: Oct. 16, 2007

(30) Foreign Application Priority Data
Oct. 17, 2006 (DE) 10 2006 048 885.7

(51) Int. Cl. F16L 27/087; B60K 17/00; F16L 27/08

(52) U.S. Cl. 285/13; 277/345; 180/337; 180/383; 188/378

(57) ABSTRACT

A rotary leadthrough for an assembly is disclosed. The rotary leadthrough includes a stator having a first fluid channel; a rotor connectable to the assembly for rotation in common around an axis of rotation and having a second fluid channel cooperating with the first fluid channel; first sealing elements on either side of the first fluid channel and the second fluid channel, the first sealing elements bearing sealingly against the rotor and the stator; second sealing elements on either side of the first fluid channel and the second fluid channel, the second sealing elements bearing sealingly against the rotor and the stator; and first leakage channels. Each first leakage channel leads away from a respective space defined by the first sealing element and the second sealing element on the same side of the first fluid channel and the second fluid channel, the rotor and the stator.

### BACKGROUND OF THE INVENTION

1. Field of the Invention

The present invention relates to a rotary leadthrough such as that which can be used especially in the drive train of a motor vehicle to supply fluid to an assembly which must be supplied with fluid and which rotates around an axis of rotation during operation.

2. Description of the Related Art

Published German Patent Application No. 10 2005 058 531 describes a torsional vibration damper in which a damping device acting between a primary side and a secondary side is designed in the manner of a gas compression spring and therefore provides damping behavior by taking advantage of the compressibility of a gaseous medium. So that the damping characteristic can be adjusted, the pressure of the gaseous medium can be changed. To do this, a pressure fluid, usually a liquid, is introduced into the torsional vibration damper through a rotary leadthrough to influence the pressure of the gaseous medium as desired. Thus it becomes possible to adapt the characteristic of this torsional vibration damper to different sets of operating conditions.

DE 100 34 730 A1 describes a so-called “wet-running” double clutch, in which torque can be transmitted from a clutch input area optionally to either one of two coaxial takeoff shafts by way of two radially offset groups of plates. The two clutch areas are actuated by a pressure fluid, and because the clutch in general is a rotating system, this fluid must be supplied by way of a rotary leadthrough.

An assembly designed in the form of a bridging clutch, which is actuated by the infeed of a pressure fluid, is also known. This assembly is part of the hydrodynamic torque converter described in U.S. Pat. No. 5,575,363. Because this hydrodynamic torque converter is also in general a rotating system, there is also the need here to take the pressure fluid from a fluid source, which is in general not rotating, and to convey it onward through a rotary leadthrough to the area where the bridging clutch is actuated.

### SUMMARY OF THE INVENTION

An object of the present invention is to provide a rotary leadthrough such as that which can be used in, for example, various areas of the drive train of a motor vehicle, namely, to provide a rotary leadthrough which makes it possible to supply highly pressurized fluid at a comparatively high volume flow rate while offering high operational reliability at the same time.

This object is accomplished according to the invention by a rotary leadthrough, especially for the drive train of a motor vehicle. The rotary leadthrough includes a rotor arrangement to be connected for rotation in common around an axis of rotation to an assembly to be supplied with fluid; a stator arrangement, which surrounds the rotor arrangement and which is to be prevented from rotating around the axis of rotation; at least one first fluid channel, which is provided in the stator arrangement; at least one second fluid channel, which is provided in the rotor arrangement, and which cooperates with the first fluid channel; a first sealing arrangement, which comprises two first sealing elements, one on each side of the minimum of one first fluid channel and the cooperating minimum of one second fluid channel, which first sealing elements rest with a sealing action against the rotor arrangement and against the stator arrangement; a second sealing arrangement, which comprises second sealing elements located on the sides of the first sealing elements which face away from the minimum of one first fluid channel and the cooperating minimum of one second fluid channel, which second sealing elements rest with a sealing action against the rotor arrangement and against the stator arrangement; and a leakage channel arrangement comprising leakage channels, which are located in the stator arrangement and/or in the rotor arrangement and which lead away from the spaces formed between the first sealing elements and the second sealing elements.

As a result of the design of the inventive rotary leadthrough with two sealing arrangements offset from each other with respect to the fluid channels to be sealed to prevent the escape of fluid, a high degree of reliability is obtained with respect to the escape of pressure fluid even when the system is operating at comparatively high pressure. Because, furthermore, spaces from which fluid can be carried away via the associated leakage channels of the leakage channel arrangement, that is, fluid which has managed to overcome the first sealing arrangement, are present between the two sealing arrangements or the respective sealing elements of these arrangements, it can be ensured that these spaces are kept essentially pressureless, so that the second sealing arrangement works under nearly pressureless conditions with respect to the fluid, which means that the fluid has practically no opportunity to escape through this second sealing arrangement.

So that the spaces required to accept the leakage fluid can be provided easily, it is proposed that the two sealing elements of at least one pair of elements consisting of a first sealing element and a second sealing element be set up a certain axial distance apart. It is also advantageous, furthermore, for the two sealing elements of at least one pair of elements consisting of a first sealing element and a second sealing element to be on approximately the same radial level. As an alternative, it is also possible for the two sealing elements of at least one pair consisting of a first sealing element and a second sealing element to be on different radial levels.

So that the rotor arrangement and the stator arrangement can be kept in a defined position with respect to each other, it is also proposed that, in at least one space between the two sealing elements of a pair consisting of a first sealing element and a second sealing element, a bearing be provided to support the rotor arrangement with respect to the stator arrangement. A design characterized by very compact axial dimensions can be realized by having the radially outer sealing element radially surround the outside of the bearing installed in the space between the two sealing elements.

In an especially advantageous embodiment, at least two first fluid channels can be provided in the stator arrangement. To prevent the exchange of fluid between these channels as well and thus to ensure that it is possible to work with different pressures in the minimum of two first fluid channels and in the cooperating second fluid channels, it is also proposed that a first sealing arrangement be assigned to each first fluid channel and the cooperating minimum of one second fluid channel in the rotor arrangement; that an intermediate space be formed between two first sealing elements of different first sealing arrangements assigned to first fluid channels; and that the leakage channel arrangement comprise a leakage channel leading away from this intermediate space.

When a single rotary leadthrough is intended to supply two assemblies of a drive train to be supplied with pressure, where these two assemblies will generally be offset from each other in the axial direction, it is proposed that the second fluid channels in the rotor arrangement cooperating with the first fluid channels be separated from each other and that they extend in opposite axial directions. This means, therefore, that the second fluid channels in the rotor arrangement cooperating with the different first fluid channels can conduct the fluid in the two opposite longitudinal directions, so that each of the assemblies, which are then adjacent to the two axial ends of the rotor arrangement, can be easily supplied.

In an alternative embodiment, it is possible for the second fluid channels in the rotor arrangement cooperating with the various first fluid channels to be separated from each other and to extend in the same axial direction. In this case, therefore, the second fluid channels lead in the same direction or to the same axial end of the rotor arrangement. This is especially advantageous when an assembly to be supplied with fluid is supplied with fluid to influence its operating characteristics, and when in addition a switching arrangement such as a switchable valve is present in this assembly, which can be switched to influence the volume flow rate of the fluid which influences the operating characteristics, the valve itself also being actuated with pressure fluid for this purpose.

The present invention also pertains to a drive train for the motor vehicle, which drive train comprises at least one assembly to be supplied with fluid, which assembly rotates around an axis of rotation to transmit torque and which is to be supplied with fluid by way of a rotary leadthrough designed in accordance with the invention.

As previously explained, it is also possible for the two assemblies to be supplied with fluid to be a certain axial distance apart and for the two assemblies to be supplied with fluid via the same rotary leadthrough.

At least one assembly can comprise a torsional vibration damper arrangement. It is also possible for at least one assembly to comprise a friction clutch such as a double clutch, where, in accordance with the present invention, a friction clutch can also obviously take the form of a bridging clutch in a hydrodynamic torque converter or a hydrodynamic clutch. At least one assembly can also be designed as a hydrodynamic torque converter.

To simplify the design further in this type of drive train by combining functions in various system areas, it is proposed that the rotor arrangement of the rotary leadthrough be in torque-transmitting connection with at least one assembly.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is explained in detail below with reference of the attached drawings:

FIG. 1 shows a schematic diagram of part of a drive train to be installed in a motor vehicle;

FIG. 2 shows a partial longitudinal cross section through a rotary leadthrough designed according to the invention;

FIG. 3 shows a view, corresponding to FIG. 2, of an alternative embodiment of a rotary leadthrough;

FIG. 4 shows a view, corresponding to FIG. 2, of an alternative embodiment of a rotary leadthrough;

FIG. 5 shows another alternative design of a rotary leadthrough in a drive train; and

FIG. 6 shows another alternative embodiment of a rotary leadthrough in a drive train.

### DETAILED DESCRIPTION OF THE PREFERRED EMBODIMENTS

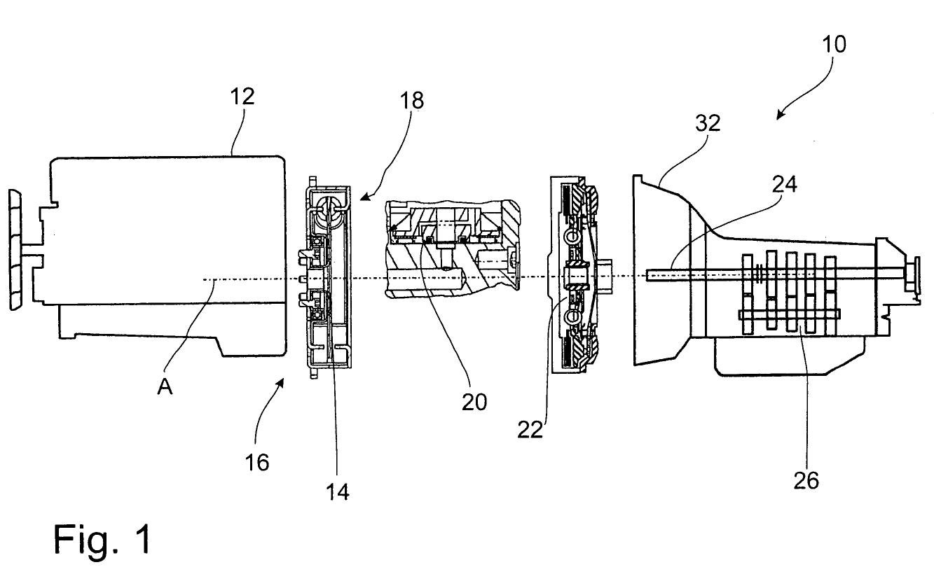

FIG. 1 shows by way of example a part of a drive train 10, which is to be installed in a motor vehicle such as a passenger car or a truck. The drive train 10 has a drive unit 12, designed in the form of, for example, an internal combustion engine, which transmits torque by way of a drive shaft, such as a crankshaft rotating around an axis A, to a torsional vibration damper arrangement 14. The torsional vibration damper can be designed, for example, as described and disclosed in published German Patent Application 10 2005 058 531. The content of this older application is herewith included by reference in the content of the present application. The torsional vibration damper arrangement 14 can therefore comprise a damper unit, designed in the manner of a gas spring, which acts between a primary side 16, which is connected to the drive unit 12, and a secondary side 18. The operating behavior or characteristic of this damper unit can be adjusted by supplying it with pressure fluid, where the pressure fluid required for this purpose is supplied and carried away through a rotary leadthrough 20, which is explained in greater detail below. With respect to the path along which the torque flows, a friction clutch 22, which can be of conventional design, is present downstream from the secondary side 18 of the torsional vibration damper 14, i.e., from the rotary leadthrough 20. The friction clutch 22 sends the torque along to a gearbox input shaft 24 of a gearbox 26. As an alternative to a friction clutch, it would also be possible to install a hydrodynamic torque converter or a double clutch, where the latter can be either of the dry-running or wet-running type.

It should be pointed out here that the various system areas of the previously explained drive train 10 are illustrated only by way of example and only for the purpose of explaining the general principles. It is obvious that a wide variety of variations is possible here.

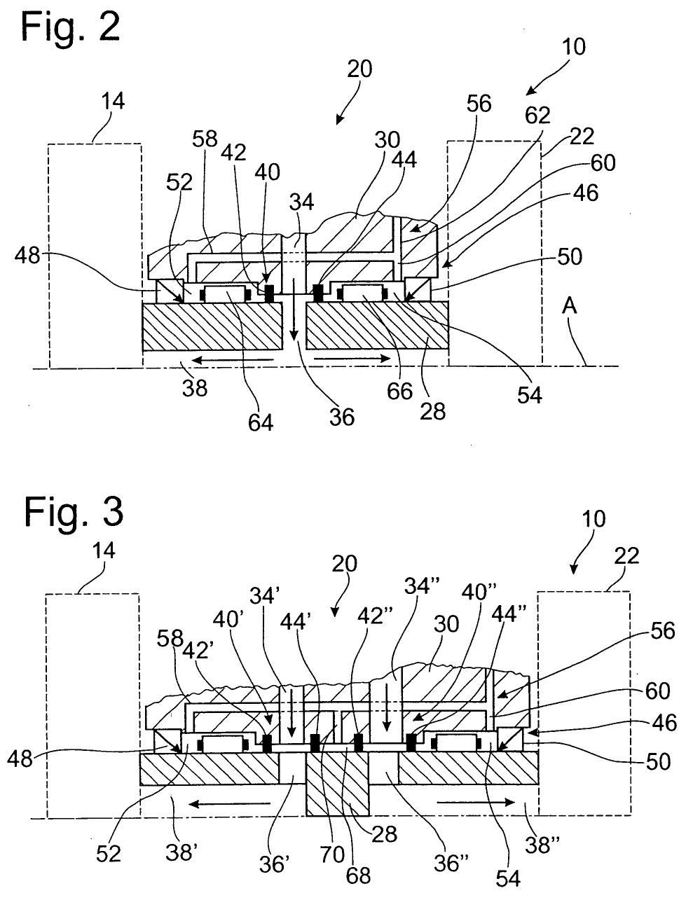

FIG. 2 shows the rotary leadthrough 20 in detail. This rotary leadthrough 20 is situated in the drive train 10 between the torsional vibration damper 14 (indicated only symbolically) and the friction clutch 22 (also indicated only symbolically). The rotary leadthrough 20 comprises a rotor arrangement 28, here designed as a section of a shaft. This rotor arrangement 28 is permanently connected at one end to the secondary side of the torsional vibration damper arrangement 14 by means of, for example, screws, and is connected at the other end to the input area of the friction clutch 22, such as a flywheel. Thus, in this design of a rotary leadthrough 20, the rotor arrangement 28 also takes over the function of transmitting torque between the two assemblies 14, 22 of the drive train 10 and is also able to rotate with these assemblies around the axis of rotation A, as should be obvious.

The rotor arrangement 28 is surrounded radially on the outside by a stator arrangement 30. This stator arrangement is fastened to a stationary assembly such as the transmission bell 32, for example, shown in FIG. 1, and is thus unable to rotate around the axis A.

The stator arrangement 30 comprises a first fluid channel 34, which is or can be connected at a radially outer end area by way of a connecting line to a source of pressure fluid. The radially inner end of this channel is open to the rotor arrangement 28. It should be pointed out here that, of course, the first fluid channel 34 can comprise a plurality of channel sections arranged a certain distance apart in the circumferential direction around the axis of rotation A and leading in the radially inward direction, so that in this way the overall flow cross section of the first fluid channel 34 can be increased.

Cooperating with this first fluid channel 34 of the stator arrangement 30 is a second fluid channel 36 in the rotor arrangement 28. This second channel 36 is located approximately in the same axial area as the first fluid channel 34 and is open to the outer circumferential area of the rotor arrangement 28. Here, too, it should be pointed out that the second fluid channel 36 in the rotor arrangement 28 can also comprise a plurality of channel sections distributed in the circumferential direction around the axis of rotation A and extending approximately in the radial direction, so that here, too, a comparatively large flow cross section can be made available. The second fluid channel 36 ends at a central opening 38 in the rotor arrangement 28, which, in the example shown here, is open to the two axial end areas of the rotor arrangement 28, so that pressure fluid introduced via the second fluid channel 36 can be conducted to the torsional vibration damper arrangement 14 and also to the friction clutch 22.

So that the two cooperating fluid channels 34 and 36 can be sealed off and the undesirable escape of fluid thus prevented, a first sealing arrangement 40 is provided. This comprises first sealing elements 42, 44, one of which is on one axial side of the cooperating fluid channels 34, 36, the other on the other axial side. These sealing elements rest with a sealing action against the stator arrangement 30 and against the rotor arrangement 28. These first two sealing elements 42, 44 of the first sealing arrangement 40 are designed as pressure seals; that is, they serve to seal off the two assemblies which rotate with respect to each other, namely, the stator arrangement 30 and the rotor arrangement 28, in an essentially fluid-tight manner even at comparatively high pressures.

A second sealing arrangement 46 comprises second sealing elements 48, 50, which are on the axial sides of the first sealing elements 42, 44 of the first sealing arrangement 40 which face away from the fluid channels 34, 36. In the present case, these second sealing elements 48, 50 are located, for example, near the axial ends of both the rotor arrangement 28 and the stator arrangement 30. As a result, a space 52, 54 is formed between each pair of sealing elements 42, 48 and 44, 50, which are axially offset from each other and approximately on the same radial level.

A leakage channel arrangement 56 in the stator arrangement 30 comprises leakage channels 58, 60, which lead away from the associated spaces 52, 54 and lead back via a collecting line 62 to, for example, a fluid reservoir. Providing the leakage channel arrangement 56 ensures that pressure fluid which manages to flow past the first sealing elements 42, 44 of the first sealing arrangement 40 cannot lead to an excessive buildup of pressure in the spaces 52, 54, but that instead it can be conducted away via the essentially pressureless leakage channel arrangement 56. The second sealing elements 48, 50 of the second sealing arrangement 46 can thus be designed essentially as volume flow-control seals and do not have to form a seal against the high pressures prevailing in the area of the fluid channels 34, 36. In this way, the escape of fluid from the rotary leadthrough 20 can be completely prevented. The fluid escaping via the leakage channel arrangement 56 can be fed back into the working circuit.

So that the rotor arrangement 28 can be supported in a defined position with respect to the stator arrangement 30 and thus so that it can be ensured that the two sealing arrangements 40 and 46 can fulfill their function reliably, a bearing 64, 66 is provided in each of the spaces 52, 54, each of these spaces being formed between a pair of sealing elements 42/48 and 44/50. These bearings 64, 66 are designed as rolling element bearings or as friction bearings. They ensure a defined radial positioning of the rotor arrangement 28 with respect to the stator arrangement 30, and at the same time they are lubricated by the fluid being used, i.e., oil or the like, provided in the form of the leakage stream in the spaces 52, 54 which is necessarily present, especially at higher pressures. It should be pointed out that, as a result of the appropriate stepped design of the stator arrangement 30 and possibly also of the rotor arrangement 28, as indicated in FIG. 2, these bearings 64, 66 can also take over the function of defining the axial positioning of these two components with respect to each other.

With the rotary leadthrough 20 seen in FIG. 2, it becomes possible, in a simple and reliable manner and above all in a fluid-tight manner, to feed several assemblies 14 and 22 of a drive train 10 with the fluid required for them to operate. It thus becomes possible to vary, for example, the damping characteristic of a torsional vibration damper 14 and thus to adapt it to various operating states of the drive train 10 or to actuate a friction clutch 22, which can be designed as a wet-running friction clutch, for example, so that it performs its engaging and disengaging operations. Especially in the case of the embodiment shown in FIG. 2, it is easy to achieve an adjustment or actuation of the two assemblies 14, 22 in coordination with each other by supplying fluid to them both simultaneously, i.e., by simultaneously increasing the pressure of the fluid being supplied to both.

FIG. 3 shows an alternative embodiment. In the following, only the differences between this embodiment and that shown in FIG. 1 will be discussed.

It can be seen in FIG. 3 that two first fluid channels 34′ and 34″ are present in the stator arrangement 30 a certain axial distance apart. Cooperating with them are second fluid channels 36′, 36″ in the rotor arrangement 28, approximately in the same axial positions as the corresponding first fluid channels 34′, 34″. A first sealing arrangement 40′ with sealing elements 42′, 44′ is assigned to the pair of fluid channels formed by the first fluid channel 34′ and the second fluid channel 36′, and a second sealing arrangement 40″ with sealing elements 42″, 44″ is assigned to the second pair of fluid channels formed by the first fluid channel 34″ and the second fluid channel 36″. Thus the two fluid channel pairs 34′, 36′, and 34″, 36″ are separated from each other and work at different pressures. What accounts in particular for this separation is that the two second fluid channels 36′ and 36″ are located in separate parts of the rotor arrangement 28 and thus lead to central openings 38′, 38″ which are not connected to each other. It is obvious that these central openings 38′, 38″ can also be interpreted as subsections of the second fluid channels 36′, 36″. In this embodiment, therefore, the two second fluid channels 36′, 36″ lead in opposite axial directions from the point where the fluid enters the rotor arrangement 28. One of the second fluid channels, namely, the second fluid channel 36′ with the central opening 38′, therefore, serves to feed the torsional vibration damper arrangement 14. The other second fluid channel 36′ with the central opening 38′ serves to feed the friction clutch 22. Thus the two assemblies 14 and 22 can be supplied and/or actuated independently of each other and also at different fluid pressures or at different fluid volume flow rates.

The independence with which the two pressure fluid-carrying volume areas are actuated can be improved even more if the intermediate space 68 formed between the two sealing elements 44′ and 42″ of the two first sealing arrangements 40′ and 40″ can be emptied through a leakage channel 70 of the leakage channel arrangement 56.

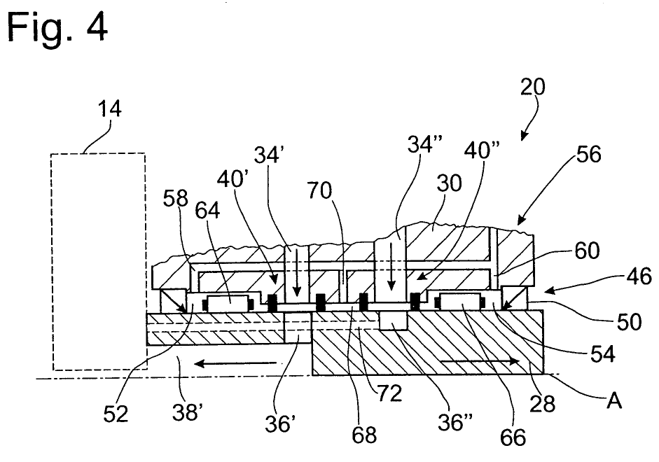

FIG. 4 shows another variation. Here, too, it is possible to see the two first fluid channels 34′, 34″ in the stator arrangement 30 and, cooperating with them, the second fluid channels 36′, 36″. The second fluid channel 36′ leads via the central opening 38′ to the torsional vibration damper arrangement 14. The second fluid channel 36″ also leads to the torsional vibration damper arrangement 14, but it does so via one or more axial openings 72, which are radially offset toward the outside from the axis of rotation A. The torsional vibration damper arrangement 14 can therefore be provided here with two different volume flows or fluid pressures. For example, a switchable valve inside the torsional vibration damper arrangement 14 can be actuated by way of the fluid channels 34″ and 36″. Inside the torsional vibration damper arrangement 14, this valve releases or at least partially blocks the volume flow of the pressure fluid being introduced via the fluid channels 34′, 36′, and as a result the damping characteristic can be influenced. The fluid channels 34″, 36″ therefore make available here essentially a control channel arrangement, whereas the fluid channels 34′, 36′ provide essentially a working pressure channel arrangement.

It is obvious that the design variants described above are merely examples and serve only to explain the principles of a rotary leadthrough 20 designed in accordance with the invention. For example, the openings or bores present in the rotor arrangement, for example, do not necessarily have to extend precisely in the radial or axial direction. Arrangements with channels which are at some other angle (i.e., not at a right angle) to each other are also possible, the purpose of this being to provide the ability, for example, to decrease the throttling effects caused by abrupt deflections of the flow. The sealing arrangements 40, 46 and their sealing elements 42, 44; 48, 50 can be designed in various ways. For example, the sealing elements 42, 44 of the first sealing arrangement 40 can be designed as open sealing rings with a T-joint. Other types of joint geometries or closed sealing rings are also possible. The sealing elements 48, 50 of the second sealing arrangement 46 can be designed as radial packing rings, for example. It is also obvious that the rotor arrangement 28 could serve only the function of fluid communication with the assembly to be supplied, that is, with the torsional vibration damper arrangement 14 and/or the friction clutch 22 and not the function of a torque-transmitting connection. This could be accomplished, for example, by means of a separate shaft or section of a shaft surrounded by the rotor arrangement, now designed as a hollow shaft section. In this case, of course, the opening designated 38, 38″ in the figures would not be a central opening; instead, it would be designed like the opening 72 in the embodiment according to FIG. 4, i.e., as an opening situated in the volume of the rotor arrangement 28.

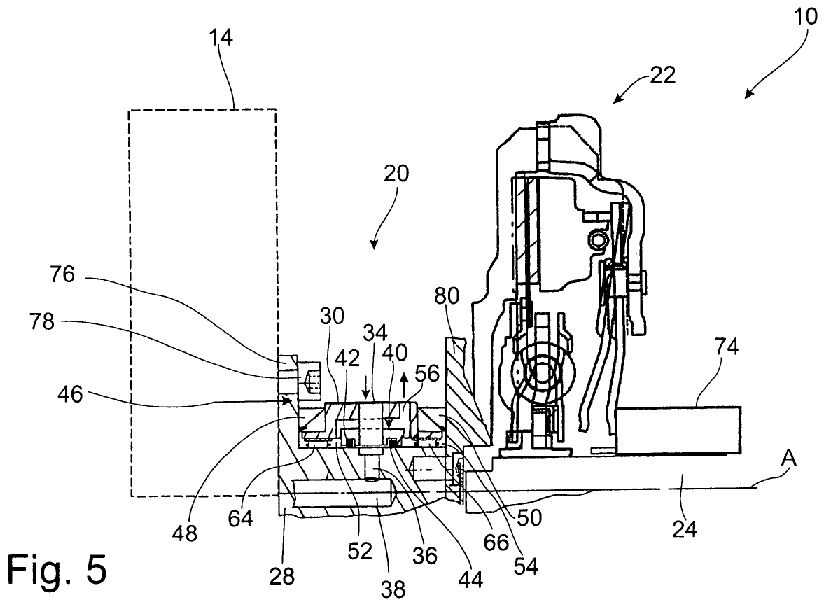

FIG. 5 shows another embodiment of an inventive rotary leadthrough 20. The embodiment of the rotary leadthrough 20 shown in FIG. 5 corresponds to the design shown in FIG. 1. The rotary leadthrough 20 therefore lies here between the torsional vibration damper arrangement 14 and the friction clutch 22, which is designed as a conventional clutch of the push type to be actuated by way of an actuating system 74.

It can be seen in FIG. 5 that the second sealing elements 48, 50 of the second sealing arrangement 46 are positioned radially outside the first sealing elements 42, 44 of the first sealing arrangement 40, namely, in such a way that they also surround the bearings 64, 66 radially on the outside. The second sealing element 48 forms a seal between the stator arrangement 30 and a radially outward-projecting flange area 76 of the rotor arrangement 28. Screws 78 passing through this flange area fasten the rotor arrangement 28 to the torsional vibration damper arrangement 14. On the other axial side, the second sealing element 50 forms a seal between the stator arrangement 30 and a flywheel mass part 80 of the input side of the friction clutch 22, which again is fastened to the rotor arrangement 28 by several screws.

As a result of the radial offset between the sealing elements 48, 50 with respect to the bearings 64, 66, a design which is extremely compact in the axial direction is obtained without loss of the spaces 52, 54 between the associated sealing elements 48, 42; 44, 50.

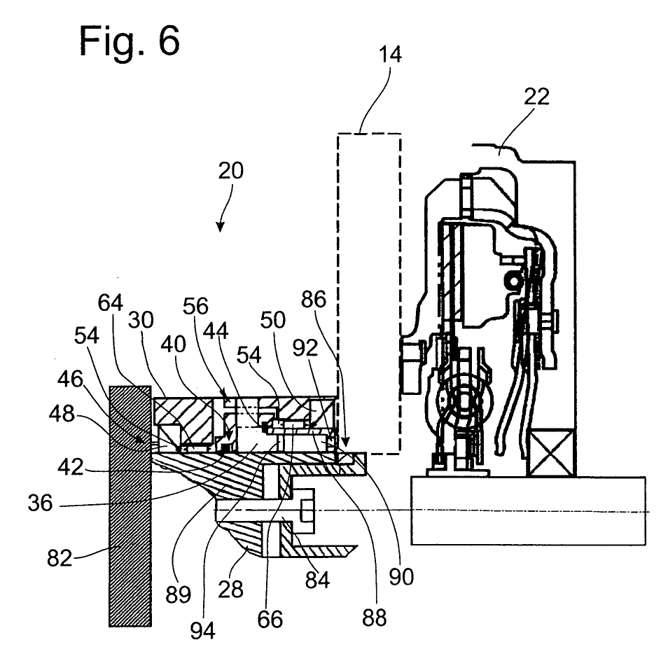

FIG. 6 shows another alternative embodiment, in which the rotary leadthrough 20 is located between a drive shaft 82, that is, for example, a crankshaft, and a torsional vibration damper arrangement 14, which in this case is upstream of the friction clutch 22. It can be seen that the rotor arrangement 28 forms an axial extension of the crankshaft 82 or is permanently screwed to it. By means of a central screw 84, the primary side of the torsional vibration damper arrangement 14 is permanently connected to the rotor arrangement 28 by sets of teeth 86 to form, for example, a positive engagement. In addition, the rotor arrangement 28 has a sleeve 88, which surrounds the end of the central part 89 of the rotor arrangement, i.e., the end near the torsional vibration damper arrangement 14. Between the sleeve 88 and the area 28, a ring-like channel 90 is formed, which provides an essential part of the second fluid channel 36. At the axial end adjacent to the torsional vibration damper arrangement 14, the sleeve 88 has an L-shaped bend and therefore rests tightly against the outside circumference of the central part 89 of the rotor arrangement 28. Several openings 92 make it possible for fluid to pass through to the torsional vibration damper arrangement 14. The other axial end of the sleeve 88 is supported radially on the inside by a support ring 94, also provided with pass-through openings.

The first sealing element 44 of the first sealing arrangement 40 acts on the end surface of the sleeve 88 and thus provides a pressure seal at this axial end with respect to the stator arrangement 30. At the end near the torsional vibration damper arrangement 14, the stator arrangement 30 is sealed off against the rotor arrangement 28 by the sealing element 50 of the second sealing arrangement 46. Between the two sealing elements 44, 50 there is again a bearing 66, which is now supported radially on the inside toward the rotor arrangement 28 by way of the sleeve 88. The space 54 is therefore formed here between the sleeve 88 and the stator arrangement 30 which extends over it radially on the outside. The bearing 64 is again located immediately between the stator arrangement 30 and the central part 89 of the rotor arrangement 28, as is also true for the second sealing element 48 of the second sealing arrangement 46.

As in the case of the other embodiments described above, a leakage channel arrangement 56 with leakage channels leading to the various spaces 52, 54 is present here again to carry away, from these spaces, the fluid which has overcome the sealing arrangement 40.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A rotary leadthrough for supplying fluid to an assembly of a drive train, the rotary leadthrough comprising:
a stator having at least one first fluid channel;
a rotor connectable to the assembly for rotation in common around an axis of rotation, the rotor being surrounded by the stator and having at least one second fluid channel cooperating with the at least one first fluid channel, first and second sides of said rotary leadthrough being defined on opposing axial sides of the at least one first fluid channel relative to said axis of rotation;
a first sealing arrangement comprising a first sealing element on each of the first and second sides of the rotary leadthrough, the first sealing elements bearing sealingly against the rotor and the stator;
a second sealing arrangement comprising a second sealing element on each of the first and second sides of the rotary leadthrough, the second sealing elements bearing sealingly against the rotor and the stator; and
a leakage channel arrangement comprising first leakage channels,
wherein each first leakage channel leads away from a respective space defined by the first sealing element and the second sealing element on each of the first and second sides of the rotary leadthrough, and by the rotor and the stator.

2. The rotary leadthrough of claim 1, wherein each pair of the first sealing element and the second sealing element on each of the first and second sides of the rotary leadthrough are axially spaced from each other.

3. The rotary leadthrough of claim 1, wherein each pair of the first sealing element and the second sealing element on each of the first and second sides of the rotary leadthrough are substantially on the same radial level.

4. The rotary leadthrough of claim 1, wherein each pair of the first sealing element and the second sealing element on each of the first and second sides of the rotary leadthrough are on different radial levels.

5. The rotary leadthrough of claim 1, further comprising a bearing in at least one said space, said bearing supporting the rotor relative to the stator.

6. The rotary leadthrough of claim 5, wherein the second sealing element of the at least one said space is axially further away from the at least one first fluid channel and radially further away from the stator than the first sealing element of the at least one said space.

7. The rotary leadthrough of claim 1, wherein the at least one first fluid channel comprises two first fluid channels.

8. The rotary leadthrough of claim 7, wherein the first sealing arrangement comprises a first sealing element on each of the first and second sides of each of the two first fluid channels, the first sealing elements disposed between the two first fluid channels, the rotor and the stator defining an intermediate space, the leakage channel arrangement further comprising a second leakage channel leading away from the intermediate space.

9. The rotary leadthrough of claim 7, wherein the at least one second fluid channel comprises two second fluid channels cooperating with the respective first fluid channels, the two second fluid channels being separated from each other and extending in opposite axial directions.

10. The rotary leadthrough of claim 7, wherein the at least one second fluid channel comprises two second fluid channels cooperating with the respective first fluid channels, the two second fluid channels being separated from each other and extending in the same axial direction.

11. A drive train for a motor vehicle, the drive train comprising:
a plurality of assemblies, at least one of the assemblies rotating around an axis of rotation for transmission of torque and being be supplied with fluid; and
a rotary leadthrough for supplying fluid to the at least one of the assemblies, the rotary leadthrough comprising:
a stator having at least one first fluid channel;
a rotor connectable to the assembly for rotation in common around an axis of rotation, the rotor being surrounded by the stator and having at least one second fluid channel cooperating with the at least one first fluid channel, first and second sides of said rotary leadthrough being defined on opposing axial sides of the at least one first fluid channel relative to said axis of rotation;
a first sealing arrangement comprising a first sealing element on each of the first and second sides of the rotary leadthrough, the first sealing elements bearing sealingly against the rotor and the stator;
a second sealing arrangement comprising a second sealing element on each of the first and second sides of the rotary leadthrough, the second sealing elements bearing sealingly against the rotor and the stator; and
a leakage channel arrangement comprising first leakage channels,
wherein each first leakage channel leads away from a respective space defined by the first sealing element and the second sealing element on each of the first and second sides of the rotary leadthrough, and by the rotor and the stator.

12. The drive train of claim 11, wherein the at least one of the assemblies consists of two of the assemblies, said two of the assemblies being axially spaced from each other and being supplied with fluid by the rotary leadthrough.

13. The drive train of claim 11, wherein the at least one of the assemblies comprises a torsional vibration damper arrangement.

14. The drive train of claim 11, wherein the at least one of the assemblies comprises one of a friction clutch, a hydrodynamic torque converter and a double clutch.

15. The drive train of claim 11, wherein the rotor of the rotary leadthrough is torque-transmittingly connected to the at least one of the assemblies.
